(19) United States
(12) Patent Application Publication
(10) Pub. No.: US 2017/0098035 A1
(43) Pub. Date: Apr. 6, 2017

(54) Medical Information System and Application

(71) Applicant: Mark A. Grevious, Chicago, IL (US)

(72) Inventor: Mark A. Grevious, Chicago, IL (US)

(21) Appl. No.: 14/873,838

(22) Filed: Oct. 2, 2015

(51) Int. Cl. G06F 19/00; H04L 29/06

(52) U.S. Cl. CPC G06F 19/322; H04L 63/102

(57) ABSTRACT

A medical information system having a medical application is presented for use on a personal electronic device. The medical application functions to create and store a medical journal within the non-transitory storage medium of the personal electronic device. The medical application can furthermore add new medical entry data to the medical journal to increase the amount of medical information contained within the medical journal. The new medical entry data may be related to past medical conditions or a new medical input of either the written, audio, or visual medium. Moreover, the medical application may be accessed to export a medical journal from the personal electronic device of the user to an outside recipient. For transmission of the medical journal from the personal electronic device, the medical application may encrypt the medical journal for secure transmission and to comply with the patient privacy standards.

### FIELD OF DISCLOSURE

The present disclosure generally relates to a medical information system, and more particularly relates to providing a protective application within the medical information system for accessing, transmitting, and documenting a patient's medical information.

### BACKGROUND OF THE DISCLOSURE

One of the basic tenets of the medical profession is to provide proper and complete medical treatment to each and every patient a practitioner may see. To properly treat each and every patient it is important that medical professionals have access to the complete medical histories of each patient. Usually during a first visit to a medical facility a new patient is asked to fill out a new patient form indicating all previous and current medical issues a patient has encountered during his or her lifetime. That information is then stored within a medical chart format for the medical professional so that when treatment is administered the medical professional will have access to that patient's medical history. Subsequent visits to the same medical professional add more information to the patient's medical chart. Overtime, a complete medical chart is formed.

In theory having one's medical history stored within the offices of the medical professional is a good solution. Such information is entrusted into the care of such medical professionals, and accessible each time the patient comes in for a medical visit. This type of situation works perfectly if a patient only needs to visit one medical professional or facility for all of his or her medical needs. However, in modern medical practice that is not the case. As the medical field advances, many medical professionals develop a specialty within distinct areas of medicine. Depending on the problems and issues a patient is having, a general medical practitioner may not be best suited to address each and every of the patient's needs. Therefore, in modern practice, patients are usually referred to specialty clinics or specialty professionals to address their unique symptoms.

Visiting multiple medical professionals is not only time consuming, but also inconveniences patients each time a new medical professional is seen. Like the first visit to the patient's main medical facility, each new visit to a specialty clinic or medical professional requires the patient to fill out a new medical history form including the patient's complete medical history. While the patient may try his or her best to remember each medical visit, a patient can forget and omit key facts which might affect treatment within the new medical facility. Therefore, it would be advantageous for a patient to have access to each of his or her medical charts maintained at each medical clinic that he or she has visited.

Additionally, patients may also be responsible for the medical care of others. Parents visiting multiple clinics with their children are not only responsible for remembering their own medical histories but also the medical histories of their children. The same is true for adult caregivers of elderly patients who must help make the medical treatment decisions available to those for whom they care. Therefore, a patient may find it advantageous to have the medical histories of his or her dependents available for new or subsequent medical visits.

However, medical records cannot just be released to any person wishing to obtain a patient's medical history. HIPAA (Health Insurance Portability and Accountability Act) laws prohibit the unauthorized sharing and transmission of a patient's medical information with parties not authorized for access. Additionally, HIPAA laws address the way in which medical information can be stored and secured within third party sites to make sure that these medical records cannot be accessed by unauthorized figures. Furthermore, HIPAA laws govern the transmission of medical records over electronic means so that the medical records are only accessed by the correct parties.

Therefore, it would be advantageous for a patient to have personal access to their complete medical histories from each and every medical facility that they have visited. Additionally, it would be further advantageous for a user legally responsible for another patient's medical care to have access to the complete medical histories of that patient as well. Furthermore, it would be beneficial that the transfer and storage of these patient medical histories is compliant with the guidelines and procedures provide by HIPAA.

While the present disclosure is directed to a system that can eliminate some of the shortcomings noted in this Background section, it should be appreciated that any such benefit is not a limitation on the scope of the disclosed principles, or of the attached claims, except to the extent expressly noted in the claims. Additionally, the discussion of technology in this Background section is reflective of the inventor's own observations, considerations, and thoughts, and is in no way intended to accurately catalog or comprehensively summarize the prior art. As such, the inventor expressly disclaims this section as admitted or assumed prior art with respect to the discussed details. Moreover, the identification herein of a desirable course of action reflects the inventor's own observations and ideas, and should not be assumed to indicate an art-recognized desirability.

### SUMMARY OF THE DISCLOSURE

In accordance with one aspect of the disclosure, a medical information system is disclosed. The medical information system has a display screen of a personal electronic device along with a device input of that personal electronic device. Furthermore, the medical information system has a networking component, a non-transitory storage medium, and a processor as part of the personal electronic device. The process or the medical information system is configured to execute instructions stored within the non-transitory storage medium to display a login screen on the display screen of the personal electronic device. The processor then can receive an identification signal base on an identification mechanism entered into the device input by a user on the login screen. From there the medical application home screen is displayed on the display screen. The processor then receives from the device input an add medical journal option based on a series of options provided on the medical application home screen. The add medical journal option is executed based on user interaction with the device input. Then, a verification signal is recognized based on user interaction with the device input that the add medical journal option has been completed, Finally, the processor executes the instructions to store the completed add medical journal option in the non-transitory storage medium. In accordance with one aspect of the disclosure, a medical information system is disclosed. The medical information system has a display screen of a personal electronic device along with a device input of that personal electronic device. Furthermore, the medical information system has a networking component, a non-transitory storage medium, and a processor as part of the personal electronic device. The process or the medical information system is configured to execute instructions stored within the non-transitory storage medium to display a login screen on the display screen of the personal electronic device. The processor then can receive an identification signal base on an identification mechanism entered into the device input by a user on the login screen. From there the medical application home screen is displayed on the display screen. The processor then receives from the device input an access a medical journal option based on a first series of options provided on the medical application home screen. The display screen then displays a medical journal home screen. The processor then receives from the device input an add new medical entry option based on a second series of options provided on the medical application home screen. The add new medical entry option is executed based on user interaction with the device input. Then, a verification signal is recognized based on user interaction with the device input that the add new medical entry option has been completed, Finally, the processor executes the instructions to store the completed add new medical entry option in the non-transitory storage medium.

In accordance with another aspect of the disclosure, a method of transferring an export journal between users of a medical application is disclosed. First, a first medical application is opened on a first personal electronic device of a first user. The first medical application being related to medical information, stored within a first non-transitory storage medium of the first personal electronic device and when executed can provide medical information to the first user. Then an export journal option is selected by the first user on a medical journal home screen of the first medical application. Next, an export journal is created and stored locally in within the first non-transitory storage medium of the first personal electronic device. Following the creation and storing of the export journal, a message is created with the export journal attached to be delivered to a second user. The message with the export journal attached is transmitted from the first user to the second user though a first networking component contained within the first personal electronic device. Then the message with the export journal attached is received by a second user from the first user through a second networking component contained within a second personal electronic device. Finally, the export journal is opened by the second user within a second medical application stored within a second non-transitory storage medium of the second personal electronic device.

These and other aspects and features will be better understood when taken in conjunction with the following drawings.

### BRIEF DESCRIPTION OF THE DRAWINGS

FIG. 1 is a schematic view of the internal components of a personal electronic device constructed in accordance with an embodiment.

FIG. 2 is a flow chart diagram of options accessible when accessing a medical application home screen of the medical application in accordance with an embodiment.

FIG. 3 is a flow chart diagram of options accessible when accessing a medical journal home screen of the medical application in accordance with an embodiment.

FIG. 4 is a flow chart diagram of options accessible when accessing an export journal option of the medical application in accordance with an embodiment.

FIG. 5 is a modified flow chart diagram of a disclosed method to transmit an export journal from a first user to a second user in accordance with an embodiment.

It should be understood that the drawings are not necessarily to scale and that the disclosed embodiments are illustrated diagrammatically and in partial views. It should be further understood that this disclosure is not to be limited to the particular embodiments illustrated herein.

### DETAILED DESCRIPTION OF THE DISCLOSURE

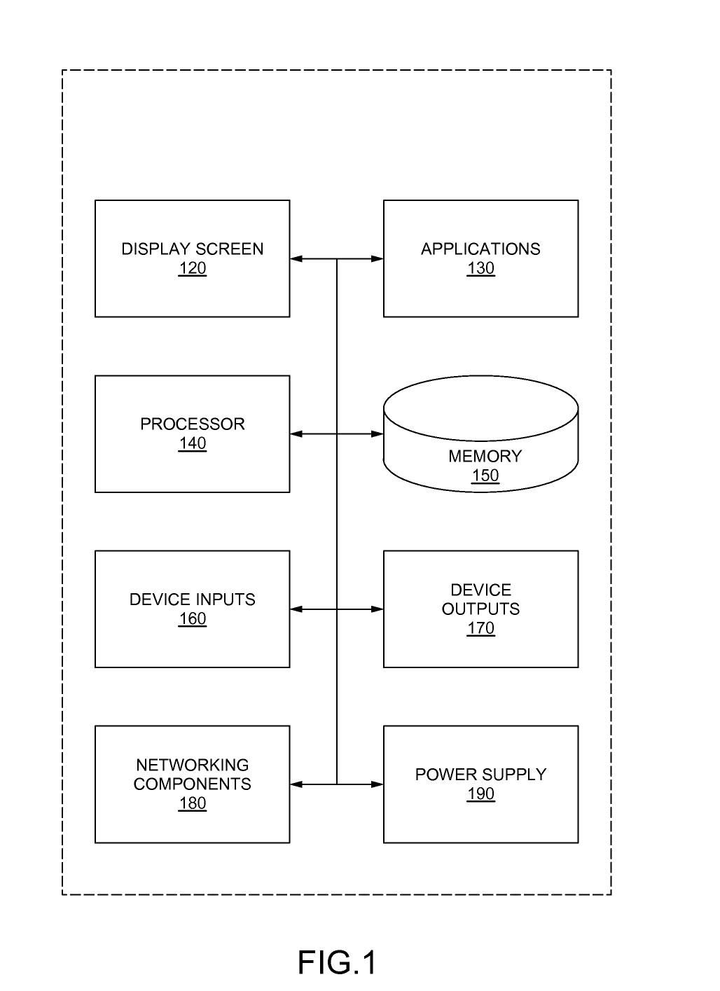

Referring now to FIG. 1, a personal electronic device 100 is depicted upon which the disclosed medical application 110 can be stored and accessed. Together, the personal device 100 and the medical application 110 form the medical information system of this disclosure. In the illustrated embodiment, the components of the personal electronic device 100 include a display screen 120, applications 130 (e.g. programs), a processor 140, a memory 150 or non-transitory storage medium, one or more device inputs 160, and one or more device outputs 170. The personal electronic device 100 may be a mobile device, such as a smartphone, a laptop computer, a tablet computer (or pad), an electronic book (eBook reader, or other mobile or personal electronic devices that may be used to communicate wirelessly (or via a fixed link) and allow the user to view and share information). Moreover, the personal electronic device 100 may also be any computer, such as a desktop computer, or processor based device that may use fixed (or wireless) links to communicate with other components and devices.

The display screen 120 may be connected to the processor 140 and memory 150 of the personal electronic device 100. When a user accesses the personal electronic device 100, the display screen 120 may visually represent the encoded software of the operating system of the personal electronic device 100 saved within the memory 150. Additionally, the display screen 120 may visually show the applications 130 accessed by the user and stored within the memory 150 of the personal electronic device 100. The display screen 120 may have the added benefit of being operable as a device input 160. As a device input 160 the display screen 120 may respond to the touch of a user or a stylus to allow the user to input information into the personal electronic device 100 regarding the operation of programs or applications 130 stored within the personal electronic device 100. Additionally, as a device input 160, the display screen 120 may be able to scan and recognize a user's fingerprints, if a user places their finger within a certain portion of the display screen 120 for recognition and input.

The processor 140 can be any of a microprocessor, microcomputer, application-specific integrated circuit, or the like. For example, the processor 140 can be implemented by one or more microprocessors or controllers within an integrated circuit design. Similarly, the memory 150 or non-transitory storage medium may reside on the same integrated circuit as the processor 140. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 or non-transitory storage medium may include a read only memory (i.e., a hard drive, flash memory or any other desired type of memory device).

The information that is stored by the memory 150 can include program code associated with one or more operating systems or applications 130 as well as informational data. The operating system and applications 130 are typically implemented via executable instructions stored in the non-transitory storage medium of the memory 150 to control basic functions of the personal electronic device 100. These functions may include interaction among various internal components of the personal electronic device 100 and storage and retrieval of applications 130 and data to and from the memory 150.

With respect to the applications 130 stored within the memory 150, these typically utilize the operating system to provide more specific functionality. In an embodiment of the present disclosure, the medical application 110 may be located within the memory 150 of the personal electronic device 100. Many applications 130 stored within the memory 150 may provide standard or required functionality of the personal electronic device 100. In other cases, applications 130 such as the medical application 110 of the disclosure provide optional or specialized functionality, and may be supplied by third party vendors.

As stated above the personal electronic device 100 may have a device input 160 and a device output 170. Examples of the device input 160 and device output 170 may include a touch display screen or a physical keyboard, a stylus, a microphone, a camera, a speaker, wireless interface, infrared interfaces, and/or other input/output interfaces which may be present on the personal electronic device 100. A user may input information through the device input 160 which would then be sent to the processor 140 and memory 150 to execute the inputted information. Furthermore, the device output 170 may produce the required output, either visually or audibly, dependent on the execution of the applications 130 or commands executed by the processor 140 of the personal electronic device 100.

Furthermore the personal electronic device 100 may include software and hardware networking components 180 to allow communications to and from the personal electronic device 100. The personal electronic device 100 may have one or more wireless access technologies or interfaces, such as a chip or component, to enable the personal electronic device 100 to establish a fixed or wireless link to an outside network. Additionally, the personal electronic device 100 may have one or more wireless technology interfaces that may communication with one or more of the other components of the personal electronic device 100. The wireless technologies and interfaces that may be used by the corresponding components of the personal electronic device 100 may include a Bluetooth interface, an Institute of Electrical or Electronic Engineers (IEEE) 802.11 compliant (or Wi-Fi) wireless interface, a new field communication (NFC) link, an Infrared Data Association interface, a Radio-Frequency identification interface or a radio frequency transponder, a reflection antenna chip, cellular interface, and or any other wireless technology interface that may be applicable to the personal electronic device. These networking components 180 provide wireless networking functionality, although wired networking may additionally or alternatively be supported.

Moreover, a power supply 190, such as a battery or fuel cell, may be included for providing power to the personal electronic device 100 and its components. All or some of the internal components communicate with one another by way of one or more shared or dedicated internal communication links 195, such as an internal bus. Through these internal communication links 195, power and data may be shared between the multiple internal components of the personal electronic device 100.

In an operational setting, the personal electronic device 100 is programmed such that the processor 140 and memory 150 interact with the other components of the personal electronic device 100 to perform a variety of functions. The processor 140 may communicate with the memory 150 to implement various modules and execute programs for different activities such as launching an application, transferring data, and toggling through various graphical user interface objects representing thumbnail images of executable programs stored within the memory 150.

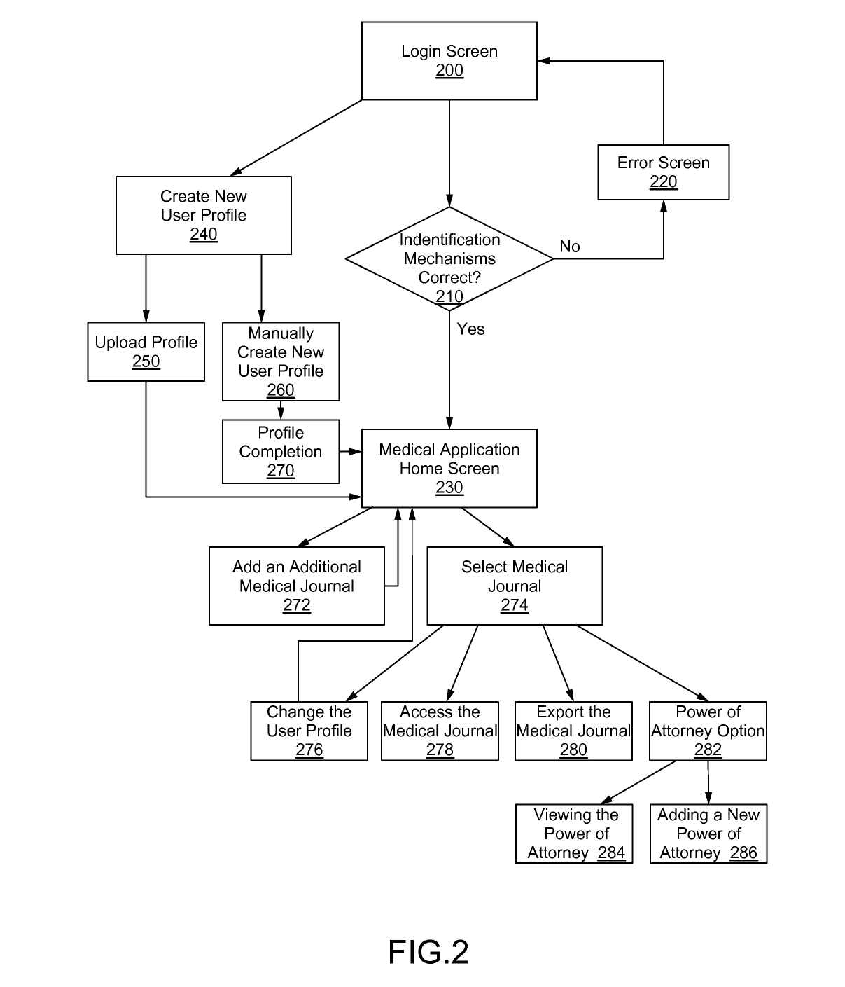

Referring now to FIG. 2, an overview of the medical application 110 is depicted in a flow chart form. As stated above, the medical application 110 may be saved within the non-transitory storage medium of the memory 150 of the personal electronic device 100. Commands entered from the device inputs 160 of the personal electronic device 100 may trigger the processor 140 of the personal electronic device 100 to access the medical application 110 within the memory 150 and execute the inputted function. Although stored within the memory 150 of the personal electronic device 100, the medical application 110 may be accessed and altered by a user with the personal electronic device 100 to change, edit, and save the medical application 110 to the user's personal preferences. Navigation of the medical application 110 by the user can be accomplished in multiple ways. For example, a user my use the display screen 120 as a device input 160 to manually navigate the menus and choices of the medical application 110. Additionally, a user may navigate the medical application 110 by using a microphone of the personal electronic device 100 as a device input 160. This would be extremely beneficial for visually impaired users employing the services of the medical application 110. Although these are two examples of device inputs 160 which may be used for navigation of the medical application 110, there may be other device inputs 160 inputs present on the personal electronic device 100 configured to navigate the user through the medical application 110.

When a user accesses the medical application 110 from the personal electronic device 100, a login screen 200 is presented on the display screen 120. On the login screen 200 the user must correctly enter his/her identity. Access to the medical application 110 may be restricted from unauthorized third parties who should not have accessibility privileges. In one exemplary embodiment, access to the medical application 110 can be restricted by a password. During initial user setup an authorized user may enter a user name and a password to protect access to their medical application 110. Each time a user logs into the medical application 110 the user name and password will be prompted for entry from the user accessing the medical application 110. Additionally, the medical application 110 may be protected by a 4 digit pin code required to enter the medical application 110. Also, in another embodiment of the present disclosure, the medical application 110 may be protected by a touch ID sensor embedded into the display screen 120 of the personal electronic device 100. With the touch ID sensor a user's fingerprint scan is saved and acts as the password protecting access to the medical application 110. On the login screen 200 protected with a touch ID sensor, the user may be prompted to place his/her finger on the display screen 120 of the personal electronic device 100 so that access may be granted to the medical application 110. When any of the identification mechanisms 210 are correctly inputted by the user, an identification signal is sent to the processor 140 allowing the user access to the medical application 110.

As stated above, on the login screen 200 the user is prompted to enter his/her correct identity through a variety of identification mechanisms 210 that may be employed by the medical application 110. If the user does not enter the correct identification mechanism 210, an error screen 220 is prompted. The error screen 220 relays to the user that the user has either entered the incorrect identification mechanism 210 or could not be recognized. From there the medical application 110 reverts back to the login screen 200 giving the user an additional opportunity to enter the correct identification mechanism 210 before access to the medical application 110 can be granted. Once a user has entered the correct identification mechanism 210, the user is taken to the medical application home screen 230.

Also contained on the login screen 200 is the create a new user profile option 240. If a new user is present, or if this is a first time set up of the medical application 110, the user should select the create a new user profile option 240 on the login screen 200. When the user selects the create a new user profile option 240, the user will be given two options regarding how the new user wishes to enter the information for the new profile. In a first option, the user may select the upload profile option 250. If, for example, the user has already used the medical application 110 on a previous personal electronic device 100 or received profile information for another user of whom he or she has legal access, the upload profile option 250 will give the user the opportunity to upload a previous user profile into the medical application 110. Once the user has uploaded the previous profile and that previous profile has been verified as compatible and complete by the medical application 110, the user is sent to the medical application home screen 230 where the user can access all the options available within the medical application 110 for use with the uploaded profile.

The second option on the create a new user profile option 240 allows the user to manually enter the necessary information to create a new user profile 260 for use with the medical application 110. By selecting this option, the user will then be asked a series of questions needed to correctly set up a new user profile 260. In an exemplary embodiment of the disclosure, the user may first be directed to enter a user name and identification mechanism 210. The identification mechanism 210 as stated above may be a password, four digit PIN code, or touch ID fingerprint or the like. From there the user may be prompted to enter personal information such as legal name, address, and date of birth. From there simple medical questions may be asked of the user and that information may be entered and saved within the new user profile 260. These questions may include but are not limited to questions regarding the user's medication use, surgical history, and allergies or the like. When the user if finished completing the new user profile 260, a profile completion screen 270 will prompt letting the user know that the user has finished and successfully entered a new user profile 260. From there the user will be taken to the medical application home screen 230 where the user can access all the options available within the medical application 110 for use with the newly created profile.

Still referring to FIG. 2, once the user has reached the medical application home screen 230 the user has a variety of paths to choose from. Viewed on the medical application home screen 230 is a list of all medical journals to which the user has access within the medical application 110. The user may also choose the add an additional medical journal option 272 on the medical application home screen 230. If the user selects the add an additional medical journal option 272, the user will have the option to either upload a new medical journal or enter the new medical journal information manually. If the user elects to enter the new journal information manually, the user will then be directed to a series of questions similar to those asked when first creating a new user profile. When the add an additional medical journal option 272 is complete, the medical application 110 will send a verification signal to the processor 140 to store the new medical journal within the memory 150 of the personal device 100. With the successfully completion of the add an additional medical journal option 272, the user is returned to the medical application home screen 230.

Also on the medical application home screen 230, the user may use the select a medical journal option 274 to choose a medical journal of which the user has access. By selecting the select a medical journal option 274 the user will have the option to proceed down four separate paths. After first choosing the select a medical journal option 274, the user may then choose the change the user profile option 276 for the corresponding journal, access the medical journal 278, export the medical journal 280, or select the power of attorney option 282. Each of these options available to the user will be discussed in detail below.

Still referring to FIG. 2, the first of the four options available to a user choosing the select a medical journal option 274 is the change the user profile option 276. If the user selects the change the user profile option 276, the user will be taken to the same questions that were asked during initial set up of that user profile. The user may then have the option to edit or changes responses to those general personal information questions and general medical information which would then in turn update the user profile of the selected medical journal. After the user has completed the change user profile option 276 the user is returned to the medical application home screen 230.

In the second option, the user may access the medical journal 278. In selecting this option the user will be taken to a different screen were a plethora of options are available to update, edit, and organize the selected medical journal based on the users wishes. Additionally, if the user selects the third option, export the medical journal 280, the user will be provided with a series of steps and options which can allow the user to send the information stored within the medical journal to an outside source. Detailed information regarding the second option, access the medical journal 278, and the third option, export the medical journal 280, are discussed below. Each of these two options provides important functionally and security to the medical application 110.

Finally, as the fourth option, the user may select the power of attorney option 282. If the user selects the power of attorney option 282 the user will be taken to a different screen giving the user the choice of either viewing the power of attorney 284 or adding a new power of attorney 286. Since the medical application 110 is designed to function with multiple medical journals, there may be some instances, especially regarding the care of elderly patients, where the user would have to receive a power of attorney to have access to the medical information of that patient. The power of attorney option 282 provides a safe storage space for such legal documents. If the user selects the option of viewing power of attorney 284, the user will then be able to view all power of attorney documents associated with the selected medical journal. Additionally, if the user selects the option of adding a new power of attorney 286, the user can upload and save a new power of attorney document to the medical application 110 and retain that new power of attorney document within the properly selected medical journal.

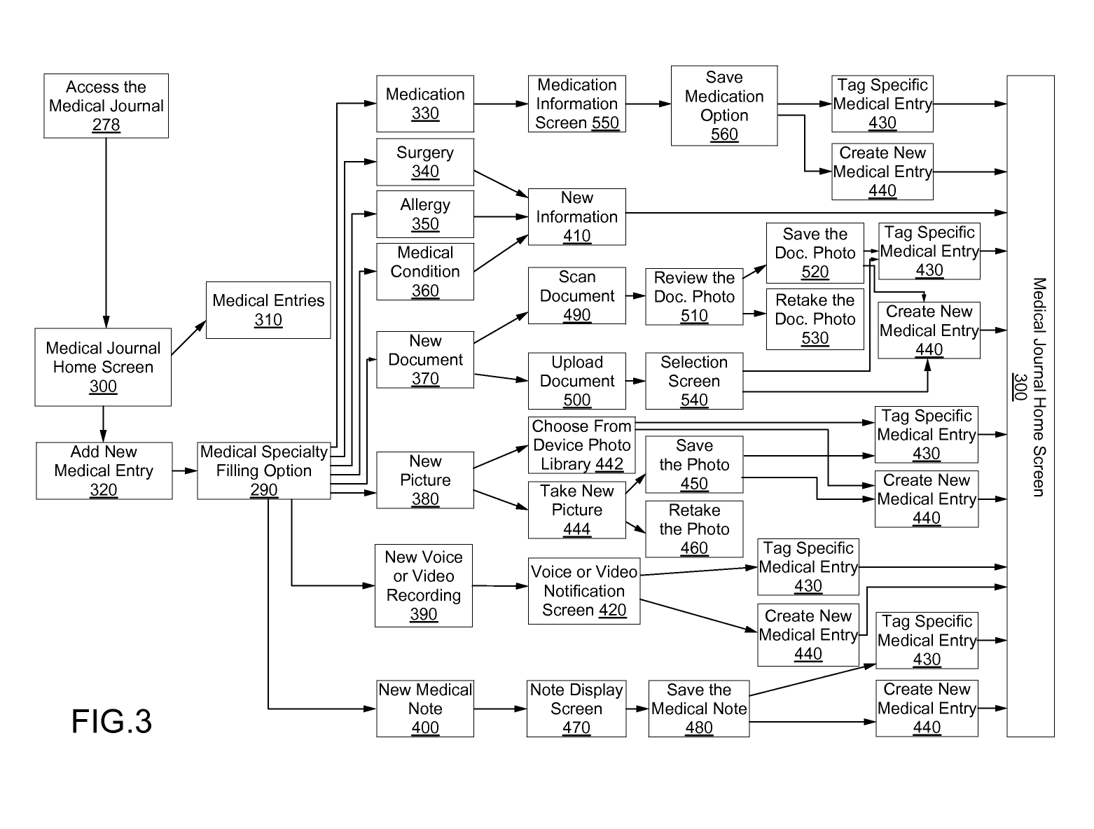

Now referring to FIG. 3, the option of accessing the medical journal 278 is depicted in a flow chart. Once the user has selected a medical journal the user is taken to a medical journal home screen 300. On the medical journal home screen 300 the user will view all the medical entries 310 entered into the specific medical journal. These medical entries 310 may include, but are not limited to doctor visits, surgery information, allergy information, medication, medical conditions, personal information, medical documents, photos, notes/text, and/or voice or video recordings. All of this information may be classified in a sub-structure type architecture. For example, a user may have had hip surgery in the past. Because of the hip surgery, medication may be needed, a specific doctor may have been visited, specific home treatment notes may have been given, and the user may have taken photographs of the physical healing process for medical review. On the user's medical journal home screen 300 the user has the option to list each of these medical entries 310 as individual occurrences. However, for organizational purposes and for ease of reading the user may want to tag each of this medical entries 310 under the heading “Hip Surgery” so that they may be easily accessed at a later date and to not clutter the medical journal home screen 300. With use of the disclosed medical application 110 the user may be able to easily tag such information for later access and viewing.

The user may also organize the medical entries by a medical specialty filing option 290. The medical specialty filing option 290 functions similarly to the “hip surgery” example discussed above. A patient may visit many different medical doctors for different medical treatments. Because of this, it may be useful for the user of the medical application 110 to organize the medical entries 310 within a specific medical specialty. These medical specialties may include but are not limited to a general practitioner, oncologist, urologist, radiologist, or any other distinct field of medical practice in which a patient may receive treatment. Medical entries 310 that have already been stored within the medical journal will already be tagged with the medical specialty filing option 290. When entering new medical entries, the process described below may be followed.

Also present on the medical journal home screen 300 is an add new medical entry option 320. The user may select the add new medical entry option 320 to add an additional piece of information to an existing medical entry 310 or to add an entirely new medical entry. After a user selects the add new medical entry option 320, a menu will appear in a scrollable drop down form allowing the user to select the medical specialty filing option 290. Once the user has selected the appropriate medical specialty in which the new medical entry will be filed, the user may proceed with adding the additional medical entry. The add new medical entry option 320 will save the new medical entry within the selected medical specialty designated from the medical specialty filing option 290.

After selecting the appropriate medical specialty from the medical specialty filing option 290, a second drop down menu will appear prompting the user to select which type of entry the user would like to add. The user may choose from adding a medication option 330, a surgery 340, an allergy 350, a medical condition 360, a new document option 370, a new picture option 380, a new voice or video recording option 390, or a new medical note option 400 or the like. If the user selects the option to add a surgery 340, an allergy 350, or a medical condition 360 a new information screen 410 will appear giving the user the opportunity to enter information about the newly entered surgery 340, allergy 350, or medical condition 360. The information requested by the medical application 110 may be specific to the new data entry selected. For example, if an allergy 350 is selected, the user may be prompted to enter information regarding the diagnosis date, diagnosis doctors, and treatment prescribed. Furthermore, in regards to the allergy 350, additional allergy related questions may be present relating to certain types of food or seasons of the year when the allergy is present or in which the patient is at added risk for complications. Once the user has finished entering the new data entry relating to a surgery 340, allergy 350, or medical condition 360, a verification signal is sent to the processor 140 to notify the medical application 110 has completed the new data entry. The user is then returned to the medical journal home screen 300.

The user may also select the new voice or video recording option 390 from the drop down menu of the add new medical entry option 320. If the user selects the new voice or video recording option 390 the medical application 110 will display a voice or video notification screen 420 telling the user to tap record to start recording a voice memo or video. A push button responsive to touch on the display screen 120 is then provided where the user can press the push button to start the recording. A device input 160 such as a microphone or camera on the personal electronic device 100 is used to record the new voice recording or new video recording. Once the recording has begun, the medical application 110 will display that the recording is in progress. When displaying the progress, the medical application 110 may provide the user with additional information regarding the length of the current recording as well as a pause and stop input options. Once the user has completed the voice or video recording, the user may press the stop button on the display screen 120. In an optional embodiment of the present disclosure the user then has the opportunity to listen to the recording or replay the video recording and either instruct the medical application to save the recording or re-record the recording if the user wishes to change what was previously recorded. The user may also have an opportunity to listen or watch the recording through the device output 170, such as a speaker of the personal electronic device 100, or the display screen 120 before determining whether or not to save the recording. When the recording is finally saved by the user, the user has the additional option to tag the recording with a specific medical entry 430 within the medical journal or to create a new medical entry 440. To complete this, a verification signal is sent through the processor 140 notifying the medical application 110 to save the recording accordingly. After this step is completed, the user will return to the medical journal home screen 300.

Still referring to FIG. 3, the user may select the new picture option 380 from the drop down menu of the add new medical entry option 320. If the user selects the add new picture option 380, the user is prompted to select from at least two options: choose from device photo library 442, or take new picture 444 with a camera. If the user selects the option to choose from device photo library 442 the medical application 110 will access the photo library of saved images within the memory 150 of the personal electronic device 100. Once a photo is selected from these saved images, the user has the option to tag the photo within a specific medical entry 430 of the medical journal or to create a new medical entry 440. To complete this, a verification signal is sent through the processor 140 notifying the medical application 110 to save the photo accordingly. After that election is complete the user is notified that the photo has been saved and the user is returned to the medical journal home screen 300.

A user may also choose to take a new picture 444 with the camera. If the user selects the take new picture 444 with camera option, the camera, a device input 160, of the personal electronic device 100 is opened within the medical application 110. Once the camera is focused on the subject of the photo, the user may press a push button on the touch responsive display screen 120 to take the photo. After the photo has been taken, the user may have an opportunity to review the photo to make sure that it is in focus and the subject of the photo is adequately viewed. The user will then be prompted by the medical application 110 to either save the photo 450 or retake the photo 460. If the user chooses to retake the photo 460, the camera of the personal electronic device 100 reopens to take an additional photo. If however the user decides that they wish to save the photo 450 that was taken, the user has the option to tag the photo within a specific medical entry 430 of the medical journal or to create a new medical entry 440. To complete this, a verification signal is sent through the processor 140 notifying the medical application 110 to save the photo accordingly. After that election is complete the user is notified that the photo has been saved and the user is returned to the medical journal home screen 300.

Also seen in FIG. 3, the user may select the new medical note option 400 from the drop down menu of the add new medical entry option 320. If the user selects the new medical note option 400, the user is taken to a note display screen 470 in which the user may enter information regarding the medical note he/she wishes to save. The note display screen 470 may have a note title where the user can enter a title regarding the purpose of the note for quick reference and access at a later date. Additionally, the note display screen 470 may have a note text body section where the user may enter the detailed medical information he/she wishes to record within this particular medical note. The user may enter information into either the note title or the note text body through any applicable device input 160 of the personal electronic device 100. This may include but is not limited to a touch display screen or keyboard, voice recognition software, and/or stylus writing recognition software installed within the memory 150 of the personal electronic device 100. Once the user has completed the necessary fields and entered the medical information, the user will have the option to save the medical note 480. If the user does not wish to save the medical note 480, the fields into which the user entered information will clear, and the user will be able to enter revised information to save. If, however, the user does elect to save the medical note 480, the user has the option to tag the medical note within a specific medical entry 430 of the medical journal or to create a new medical entry 440. To complete this, a verification signal is sent through the processor 140 notifying the medical application 110 to save the medical note 480 accordingly. After that election is complete the user is notified that the medical note has been saved and the user is returned to the medical journal home screen 300.

Additionally, the user may select the new document option 370 from the drop down menu within the add new medical entry option 320. After selecting the new document option 370 the user will be prompted to decide from either a scan document option 490 or an upload document option 500. If the user selects the scan document option 490, the camera, a device input 160 of the personal electronic device 100 is opened within the medical application 110. Once the camera is focused on the document, the user may press a push button on the touch display screen to take a photo of the document. Additionally, the camera of the personal electronic device 100 may employ a scanning technology in which codes, such as QR codes or bar codes, are recognized by the camera and the corresponding document is downloaded and viewed on the display screen 120. After the photo of the document has been taken, the user may have an opportunity to review the document photo 510 to make sure that it is in focus and that the document is adequately viewed. The user will then be prompted by the medical application 110 to either save the document photo 520 or retake the document photo 530. If the user chooses to retake the document photo 530, the camera of the personal electronic device 100 reopens to take an additional document photo. If however the user decides that they wish to save the document photo 520 that was taken, the user has the option to tag the document photo within a specific medical entry 430 of the medical journal or to create a new medical entry 440. To complete this, a verification signal is sent through the processor 140 notifying the medical application 110 to save the document accordingly. After that election is complete the user is notified that the document photo has been saved and the user is returned to the medical journal home screen 300.

Furthermore, the user may elect to upload a document to the medical journal. If the user selects the upload document option 500, the medical application 110 may recognize saved medical downloads within the memory 150 of the personal electronic device 100 and provide a selection screen 540 to the user to select which file of the saved medical downloads the user wishes to upload. Once the user had selected the document he/she wishes to upload to the medical journal, the user may save the uploaded document. Before completing the save of the uploaded document, the user may be asked whether to save the uploaded document within a specific medical entry 430 of the medical journal or to create a new medical entry 440. To complete this, a verification signal is sent through the processor 140 notifying the medical application 110 to save the document accordingly. After that election is complete the user is notified that the uploaded document has been saved and the user is returned to the medical journal home screen 300.

The last option from the drop down menu within the add new medical entry option 320 allows the user to add a medication to the medical journal. If the user selects the add medication option 330, the medical application 110 displays a medication information screen 550. Within this medication information screen 550 the user is prompted to enter information regarding the medication that will be added to the medical journal. First, the name of the medication may be entered into the medication name text box. Next, a user may enter the dosage amount within the dosage text box. Then, the user may enter how many pills of the medication the user has in the number of pills text box. From there, to help the user properly identify and track the new medication, the user may be prompted to enter visual information regarding the medication. Multiple colors may be present under the heading “Color of Pill” in which the user will select the color most appropriate to the actual physical color of the medication the user is entering. Also, under the “Shape of Pill” heading the user may select the shape of the medication from a variety of shapes aiding the user in easy and correct identification of the medication entered. To further help track a user's medication needs, the user may additionally be prompted to enter a start date and an end date for the medication. Once all this information has been entered regarding the new medication the user may select the save medication option 560 to save the medication within the medical journal. Like the other options available above and before saving the medication, the user may be asked whether to save the medication within a specific medical entry 430 of the medical journal or to create a new medical entry 440. To complete this, a verification signal is sent through the processor 140 notifying the medical application 110 to save the medication accordingly. After that election is complete the user is notified that the medication has been saved and the user is returned to the medical journal home screen 300.

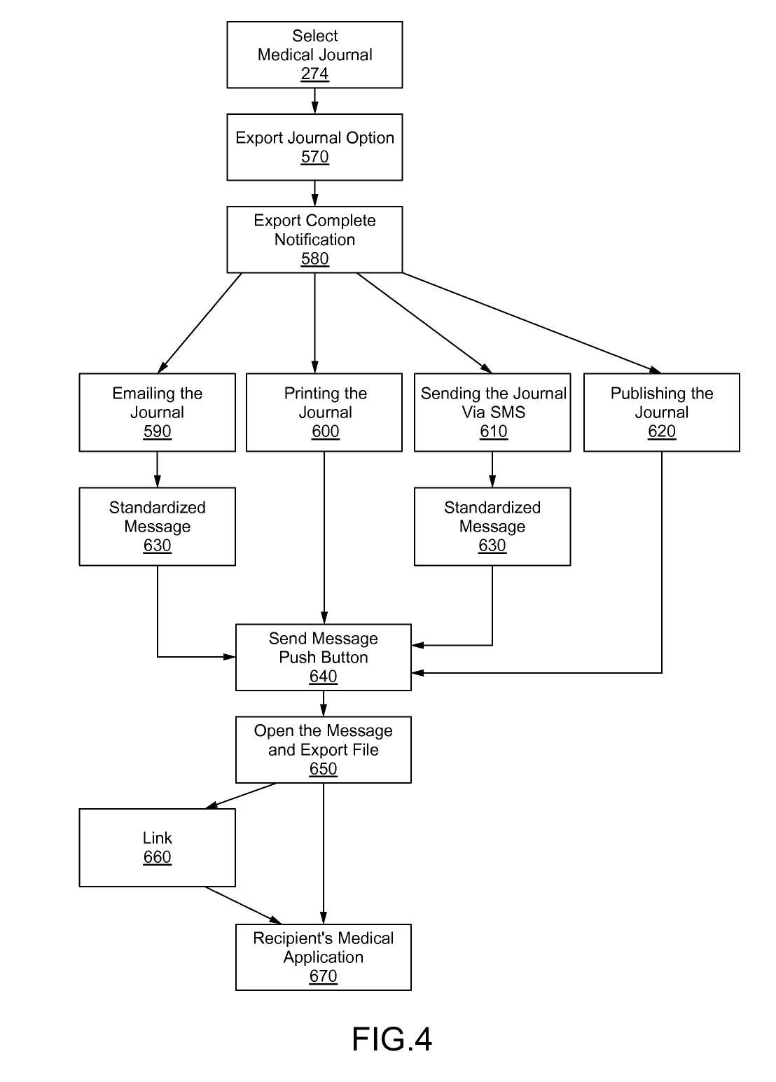

Referring now to the FIG. 4, after electing the select a medical journal option 274, a user may choose an export journal option 570 to export the medical journal 280. The export journal option 570 allows for the user of the medical application 110 to export a specific medical journal into a file which can then be sent to another device or recipient. The details of how the medical journal can be exported and sent will be discussed in greater detail below. After choosing the select a medical journal option 274 the user may select the export journal option 570. If the export journal option 570 is selected, the medical application 110 displays a notification that the medical journal is being exported and then displays a notification that the exportation of the medical journal is complete. With the export complete notification 580, the user has access to at least four different ways of sending the exported medical journal. The user may choose from emailing the journal 590, printing the journal 600, sending the journal via SMS 610, or publishing the journal 620. Depending on the option selected, the medical application 110 may create a standardized message 630 detailing that the enclosed file is a medical journal. This standardized message 630 may be edited by the user to relay whatever additional information the user wishes to state in the message sent with the export file. Additionally, the user may add additional email addresses or telephone numbers in the case of SMS messaging to the recipient list so that the medical journal may be sent to more than one recipient. Once the user is satisfied with the standardized message 630 to be included with the export file and that the recipient information is correct, the user may press the send message push button 640 on the touch responsive display screen 120 of the personal electronic device 100. The standardized message 630 and export file will then be sent to the recipient via the transmission means indicated by the user. To send this standardized message 630 and export file the medical application 110 will access the software and hardware networking components 180 of the personal electronic device 100 so that the standardized message 630 and export file are sent via the appropriate means.

The recipient of the message and export file will then have the opportunity to open the message and export file 650. If the recipient does not have access to the medical application 110, a link 660 will appear within the sent standardized message 630 directing the recipient to the appropriate location where the recipient may be able to download the medical application 110. Once the recipient has the medical application 110 and has opened the medical application 110 the recipient will be able to open the export file. After opening the export file in the medical application 110 of the recipient's personal electronic device, the recipient will be prompted to save the exported medical journal within the recipient's medical application 670 just as if they were creating a new medical journal.

The medical application 110 as disclosed wishes to remain HIPAA compliant. HIPAA laws restrict access of individual medical information to third party users who should not have access to such information. To protect a patient's privacy, it is important that security technologies are in place conforming to the compliance standards provided by HIPAA. This includes a strategic approach to security that includes both administrative and physical safeguards. These safe guards are not exclusive and must be tailored to the data storage and transmission used for the patient's medical information. Examples of adequate security technologies, include but are not limited to: daily review of user log activity, file integrity monitoring, web application firewall services, two-factor authorization, vulnerability scanning of servers and hosting machines, patch management for updates software programs, antivirus software for hosted communication programs, secure sockets layer certificate usage, and encryption of transmitted data information. While all of these protections may be employed in some capacity within the medical application 110, the detailed nature of protection implemented during the transmission data can be viewed below.

To remain HIPAA compliant the medical journals of the medical application 110 are stored locally within the memory 150 of the personal electronic device 100. These medical journals are not able to be transmitted or accessed by outside devices or networks connected to the personal electronic device 100. This is for additional security regarding the medical information contained within the medical application 110. Current developments in malware, and hacking have proven access to servers and third party systems storage systems as a viable route for the retrieval and dissemination of personal information. As these medical journals remained stored locally within the memory 150 of the personal electronic device 100, they are not stored remote from the personal electronic device 100 on other servers or networks to which the personal electronic device 100 can connect. This helps to reduce the chance of third party infection and outside influences that can make the medical information within the medical application 110 vulnerable to attack. Only the user can determine when, and how the medical application 110 connects to the outside network or internet. This is the only time the medical application 110 is connected, and only does so for a limited about of time for transmission means. Therefore, when these medical journals are transferred over a network, it is important that they cannot be accessed by third parties to which they are not intended.

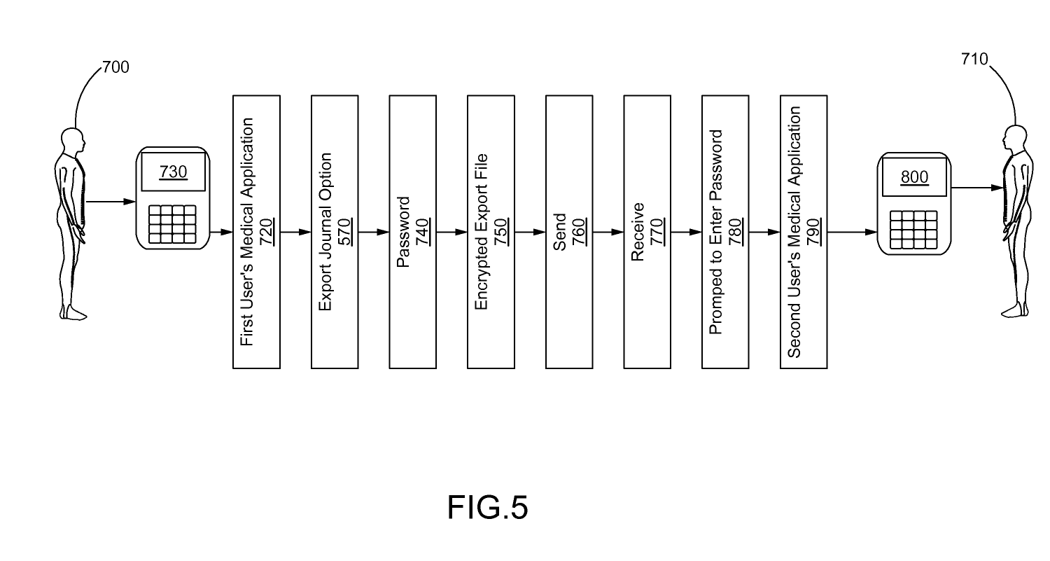

FIG. 5 depicts a modify flow diagram pertaining to the exportation and encryption of files within the medical application 110. In FIG. 5, a first user 700 wishes to share his/her medical journal with a second user 710. The first user must then enter the first user's medical application 720 on the first user's personal electronic device 730 and use the export journal option 570 from the select a medical journal option 274. After selecting the export journal option 570 the first user 700 may enter a password 740 or four digit PIN code for the newly created export file. The first user's medical application 720 then creates an encrypted export file 750 using the password 740 or the four digit PIN code as a key of the encryption. The first user 700 can then send the encrypted export file 750 to the second user 710 via any method they wish (e.g. email, SMS, chat programs, or the like).

The second user 710 will then receive 770 the encrypted export file 750 via the selected method from the first user 700. To view the encrypted export file 750 the second user 710 must have access to the medical application 110. The encrypted export file 750 is saved in a way that the encrypted export file 750 cannot be opened on any other platform besides the disclosed medical application 110. Furthermore, the encryption of the export file renders the file completely meaningless and useless if it is not opened within the medical application 110. This helps protect the first user's medical information while allowing the medical application 110 to remain HIPAA compliant.

If the second user 710 does have the medical application 110 the second user 710 may then open the encrypted export file 750. Upon opening the file within the medical application 110 the second user 710 will be prompted to enter the password 780 or four digit PIN code so that the second user 710 may access the encrypted export file 750. When the correct password or four digit PIN code is entered, the second user's medical application 790 will then use that key to decrypt the data into the original format to use within the second user's medical application 790. If the second user 710 does not enter the correct password 740 or four digit PIN code the encrypted export file 750 remains within the encrypted state and unusable by the second user 710. The second user 710 may then open the decrypted export file within the second user's medical application 790 and save the first user's medical journal within the memory 150 of the second user's medical application 790 on the second user's personal electronic device 800. From this moment on, the second user 710 will be able to view and edit the first user's medical journal within the second user's medical application 790.

### INDUSTRIAL APPLICABILITY

From the foregoing, it may be appreciated that the medical application disclosed herein may have industrial applicability in a variety of settings such as, but not limited to, personal use within a user's smartphone or other personal electronic device. The envisioned medical application would be available for use by the user on all mobile platforms. This may include current software platforms for mobile application operating systems as well as future platforms (i.e. iOS, Android, Fire OS, Cyanogen OS, Flyme OS, MIUI OS, Tizen, Windows Phone, Firefox, Sailfish, Ubuntu Touch, or the like). Alternatively, the medical application may be used by health care institutions, health care provider offices, or insurance health care carriers. The envisioned medical application may produce a medical journal for a user having a multitude of medical entry options. Personal users or medical related businesses would be aided by having medical journals easily accessible while allowing adequate protection of the medical information relating to the patient who is disclosed within the medical journal.

The medical application may be able to create and store medical entry data relating to a user's medical visits to either providers or institutions. This information provided by the medical institution or provider may include: the site and date of the doctor or health care visit; instructions given by the health care professional; a video record of the health care visit; recorded instructions given by health care professional; PDF's of medical records; radiographic images; laboratory results such as Hb, WBC, K+, Na, and so forth; operative reports; pathology reports; occupation and physical therapy results; EMG reports; radiologic reports; TB/PPD/blood tilter information; retinal scan information; retinal scan images; eye glass prescription scan; ultrasound images; breast lesion images; colonoscopy results, endoscopy records; and any other information that may be related to a specific medical visit. Keeping all the user's medical visit information within the medical application allows the user access to past treatments and records when visiting new practitioners or clinics for treatment.

The disclosed medical application may also create and store medical entry data relating to a user's detailed medical history. A user's detailed medical history may include: PAP smear history; diabetic blood sugar history; smoking cessation history; sleep apnea history; heartrate/holter monitor type history; history of sun exposure and sun block usage; sexual history; GYN history; orthopedic history; infections disease history; internal medicine history; pulmonary history; family history of cardiac events; personal history of cardiac events; oral history; seizure history; ENT history; alcoholic history; urinary frequency history; bowel history; cancer history; seasonal allergies history; food allergy history; insect allergy history; cognitive/memory loss history; hearing loss history; hair loss history; physical and exercise history; history of computer usage; history of prosthetic usage; global travel history; OB history; or any other significate medical information relating to the patients past medical issues. Such medical history information would be very helpful and easy to forward on to new practitioners and other health care facilities when the user visits for new medical treatment.

The disclosed medical application may also store and create new medical entry data options relating to a user's medication use. A user's medication use may include: adding new medication into the medical application; taking photographs of pills consumed by the user; medication alerts when it is time to take a certain medication; taking an inventory of medication that may be updated through scheduled usage; medication prescription scans; medication prescription organization; or any other medical information relating to the use of prescribed medication. Such medication use would be helpful for a user to have all the information centrally located within the medical application, as well as providing information relating to medication use to new doctors or health care clinic when a new appointment is scheduled.

The disclosed medical application may also store and create new data entries relating to a user's nutritional health. Data relating to a user's nutritional health may include: a dietary log of eating habits; a log of restaurants visited; weight measurements; body fat measurements; shoe size; dress size; a text food diary; water intake; cross communication of health and fitness information with other installed applications on the user's device; and any other information that may relate to the user's nutritional health. By organizing the user's nutritional health in a common location within the medical application a user can easily check the progress and choices made by the user relating to weight loss and dietary needs.

Also, the disclosed medical application may provide alerts and interactive resources relating to a user's personal daily health. Such alerts and interactive resources include: taking pictures of skin lesion with timestamps and timelines for dermatology needs; taking pictures of injuries within a timestamped log; recording a GPS location stamp where an illness is first observed; recording a GPS location stamp where a skin lesion was first observed; alerts relating to patient compliance with medical treatment; an interactive summary screen of medical information in preparation for the day; an alert for monthly self-breast examinations; an encrypted sex partner record; free text occurrence history relating to the patients disclosed medical history; an alert for birth control; an alert for exercise; daily checklists for health of the user or dependents; an alert for spouse/signification other well-being checks; interactive mind games to improve memory; an interactive hair loss graphic; interactive graphic body parts to enable injury reporting; emergency button with generic emergency information relating to the patient; timestamp and asthma attack history; timestamp and headache history; timestamp and nausea/vomiting history; timestamp and carpal tunnel pain history; interactive chest pain history pain reporting; an alert for the start of the menstrual cycle; an alert for a mental health screen; timestamp and emotional data history; alert for time since last vacation; interaction summary of medical events recorded throughout the day; and any other medical information and alerts which may help a user maintain medical health throughout his/her daily routine. Such alerts and interactive medical information help a user stay on top of his/her daily medical needs while also recording specific occurrences of medical events which may be useful in diagnosing new medical issues in upcoming medical visits.

The disclosed medical application may additionally provide encryption tools to protect personal and family data relating to the user as well as upholding a user's HIPAA rights. Such protection of personal and family information may include: not connecting the medical application to the internet to allow for HIPAA protection of user medical journals; encrypting medical information; creating multiple profiles of dependents such as children; parents, pets or spouses; storing immunization schedules for dependents; storing dependents oral history; storing dependents autistic history; storing insurance information; storing billing information; storing diver license information; storing Medicare information; storing finger prints for encryption and protection purposes; storing passwords and four digit PIN codes for encryption and protection; providing a financial section within the medical application for the user; and any other protection or encryption methods that may aid the user in guarding his/her personal and medical information. By protecting the user's personal and medical information, the medical application provides a safe HIPAA compliant platform for the user to store information for personal use as well as securely transfer information to others having the legal rights to access the user's medical journal.

While the foregoing detailed description has addressed only specific embodiments, it is to be understood that the scope of the disclosure is not intended to be limiting. Thus, the breadth and spirit of this disclosure is intended to be broader than any of the embodiments specifically disclosed and/or encompassed within the claims appended hereto.

What is claimed is:

1. A medical information system comprising:
a display screen of a personal electronic device;
a device input;
a networking component;
a non-transitory storage medium; and
a processor, the processor configured to execute instructions stored within the non-transitory storage medium for:
displaying a login screen on the display screen;
receiving an identification signal based on an identification mechanism entered into the device input by a user on the login screen;
displaying a medical application home screen on the display screen associated with the identification signal of a correct identification mechanism;
receiving from the device input an add medical journal option based on a series of options provided on the medical application home screen;
executing the add medical journal option based on user interaction with the device input;
recognizing a verification signal based on user interaction with the device input that the add medical journal option has been completed; and
storing the completed add medical journal option in the non-transitory storage medium.

2. The medical information system according to claim 1, wherein the personal electronic device is a smartphone.

3. The medical information system according to claim 2, wherein receiving the identification signal based on the identification mechanism entered into the device input by the user involves entering a password or a four digit PIN code stored by the user.

4. The medical information system according to claim 2, wherein receiving the identification signal based on the identification mechanism entered into the device input by the user involves placing a finger onto the device input of the personal electronic device, the device input of the personal electronic device being able to scan and recognize the finger based on a fingerprint stored by the user for access.

5. The medical information system according to claim 2, wherein the login screen includes a create new user profile option.

6. The medical information system according to claim 2, wherein the series of options provided on the medical application home screen includes the add medical journal option, a select medical journal option, and a change user profile option.

7. The medical information system according to claim 2, wherein executing the add medical journal option based on user interaction with the device input further comprises uploading a previous medical journal saved within the non-transitory storage medium.

8. The medical information system according to claim 2, wherein executing the add medical journal option based on user interaction with the device input further comprises answering a series of questions relating to a user's medical information and a user's personal information.

9. The medical information system according to claim 2, wherein after storing the completed add medical journal option in the non-transitory storage medium, the user is returned to the medical application home screen.

10. A medical information system comprising:
a display screen of a personal electronic device;
a device input;
a networking component;
a non-transitory storage medium; and
a processor, the processor configured to execute instructions stored within the non-transitory storage medium for:
displaying a login screen on the display screen;
receiving an identification signal based on an identification mechanism entered into the device input by a user on the login screen;
displaying a medical application home screen on the display screen associated with the identification signal of a correct identification mechanism;
receiving from the device input an access a medical journal option based on a first series of options provided on the medical application home screen;
displaying a medical journal home screen on the display screen;
receiving from the device input an add new medical entry option based on a second series of options provided on the medical journal home screen;
executing the add new medical entry option based on user interaction with the device input;
recognizing a verification signal based on user interaction with the device input that the add new medical entry option has been completed; and
storing the completed add new medical entry option in the non-transitory storage medium.

11. The medical information system according to claim 10, wherein receiving from the device input the add new medical entry option based on the second series of options provided on the medical journal home screen provides the user with a drop down list of new medical data entry options including a surgery, an allergy, a medical condition, a new medication option, a new document option, a new picture option, a new voice or video recording option, and a new medical note option, the user selecting from the drop down list of new medical data entry options either the surgery, the allergy, the medical condition, the new medication option, the new document option, the new picture option, the new voice or video recording option, or the new medical note option as the add new medical entry option the user wishes to add.

12. The medical information system according to claim 11, wherein the user selects either the surgery, the allergy, or the medical condition, the user then prompted to complete questions and enter information relating to the elected surgery, allergy, or medical condition with the device input.

13. The medical according to claim 11, wherein the user selects the new voice or video recording information system, the new voice or video recording further comprising:
prompting the user to press a push button viewable on the device input to start the new voice or video recording;
digitally recording the new voice or video recording based on a user input into the device input;
recognizing a verification signal based on user interaction with the device input electing to tag the new voice or video recording either as the new medical data entry or to tag the new voice or video recording as part of a preexisting medical data entry; and
storing the new voice or video recording into the non-transitory storage medium.

14. The medical information system according to claim 11, wherein the user selects the new picture option, the new picture option further comprising:
prompting the user to select with the device input a new picture from either a personal electronic device photo library or taking the new picture with a camera input of the personal electronic device;
recognizing a verification signal based on user interaction with the device input electing to tag the new picture either as the new medical data entry or to tag the new picture as part of a preexisting medical data entry; and
storing the new picture into the non-transitory storage medium.

15. The medical information system according to claim 11, wherein the user selects the new document option, the new document option further comprising:
prompting the user to select with the device input from either a scan document option or an upload document option;
creating a new document by selecting either the scan document option or the upload document option;
recognizing a verification signal based on user interaction with the device input electing to tag the new document either as the new medical data entry or to tag the new document as part of a preexisting medical data entry; and
storing the new document into the non-transitory storage medium.

16. The medical information system according to claim 11, wherein the user selects the new medical note option, the new medical note option further comprising:
accessing and displaying a note display screen on the display screen;
prompting the user to enter text with the device input into both a note title and a note text body of the note display screen to create a new medical note;
recognizing a verification signal based on user interaction with the device input electing to tag the new medical note either as the new medical data entry or to tag the new medical note as part of a preexisting medical data entry; and
storing the new medical note into the non-transitory storage medium.

17. The medical information system according to claim 11, wherein the user selects the new medication option, the new medication option further comprising:
accessing and displaying a medication information screen on the display screen;
prompting the user to enter text with the device input into a medication name text box, a number of pills text box, and a dosage text box of the medication information screen to create a new medication;
prompting the user to select with the device input a color of the new medication and to select a shape of the new medication on the medication information screen;
recognizing a verification signal based on user interaction with the device input electing to tag the new medication either as the new medical data entry or to tag the new medication as part of a preexisting medical data entry; and
storing the new medication into the non-transitory storage medium.

18. A method of transferring an export journal between users of a medical application within a medical information system, the method comprising:
opening a first medical application on a first personal electronic device of a first user, the first medical application stored within a first non-transitory storage medium of the first personal electronic device and having instructions which, when executed can provide medical information to the first user;
selecting an export journal option by the first user on a medical journal home screen of the first medical application;
creating an export journal stored locally within the first non-transitory storage medium of the first personal electronic device;
creating a message with the export journal attached to be delivered to a second user;
transmitting the message with the export journal attached from the first user to the second user through a first networking component contained within the first personal electronic device;
receiving the message with the export journal attached from the first user to the second user through a second networking component contained within a second personal electronic device; and
opening the export journal by the second user within a second medical application stored within a second non-transitory storage medium of the second personal electronic device.

19. The method of transferring the export journal according to claim 18, wherein creating the export journal encrypts the export journal before transmission, the encrypted export journal being protected by a key, the key being a four digit PIN code or password created by the first user during the creation of the export journal.

20. The method of transferring the export journal according to claim 18, wherein opening the export journal by the second user prompts the second user to download the second medical application if the second medication application is not detected within the second non-transitory storage medium of the second personal electronic device.
